(19) United States
(12) Patent Application Publication
(10) Pub. No.: US 2016/0037067 A1
(43) Pub. Date: Feb. 4, 2016

(54) METHOD FOR GENERATING IMAGE AND ELECTRONIC DEVICE THEREOF

(71) Applicant: Samsung Electronics Co., Ltd., Gyeonggi-do (KR)

(72) Inventors: Woo-Yong LEE, Gyeonggi-do (KR); Jae-Dong KIM, Seoul (KR); Jung-Eun LEE, Gyeonggi-do (KR)

(21) Appl. No.: 14/816,316

(22) Filed: Aug. 3, 2015

(30) Foreign Application Priority Data
Aug. 1, 2014 (KR) 10-2014-0099302

(51) Int. Cl. H04N 5/232; H04N 5/353; H04N 5/243; H04N 5/235

(52) U.S. Cl. CPC H04N 5/23232; H04N 5/23277; H04N 5/23293; H04N 5/23296; H04N 5/2351; H04N 5/353; H04N 5/243; H04N 5/23212

(57) ABSTRACT

A method and an electronic device are disclosed. The electronic device includes a camera, an illumination sensor, and at least one processor. The processor executes the method, including determining, by at least one processor of the electronic device, a photographic condition and selecting a number of photographic captures to be executed in a multi-image frame photographing mode based on the determined photographic condition, capturing by the camera multiple image frames based on the number of photographic captures, and generating an image having a predetermined image resolution from the captured multiple image frames.

### CLAIM OF PRIORITY

This present application is related to and claims the priority under 35 U.S.C. §119(a) of a Korean Patent Application No. 10-2014-0099302 filed in the Korean Intellectual Property Office on Aug. 1, 2014, the entire disclosure of which is hereby incorporated by reference.

### TECHNICAL FIELD

The present disclosure relates to electronic device and more particularly to a method for generating an image and an electronic device thereof.

### BACKGROUND

An electronic device may photograph a picture in various scenarios. The electronic device may photograph several images and then synthesize the several images into one image. For example, when an image is photographed in a low illumination environment, the electronic device may photograph several images and synthesize the photographed images, producing a single composite image that has an improved image quality relative to a single image taken in the low illumination environment. Further, the electronic device may apply various correction effects to the photographed image so that the image quality can be further improved.

### SUMMARY

An electronic device uses configured correction algorithm in order to improve image quality without account for a situations or conditions of a photographing environment of the electronic device. Therefore, the image quality may be degraded when a picture is captured in a low illumination environment.

The present disclosure provides a method and an electronic device apparatus for generating a high resolution image by applying a multi-image frame photographing mode, utilized in, for example, a particular photographic state, such as capturing images in a low illumination environment, a poorly illuminated object, or image capture while utilizing a digital zoom.

According to one embodiment of the present disclosure, a method in an electronic device is disclosed, the method comprising: determining, by at least one processor, a photographic condition and selecting a number of photographic captures to be executed in a multi-image frame photographing mode based on the determined photographic condition, capturing, by a camera, multiple image frames based on the number of photographic captures, and generating an image having a predetermined image resolution from the captured multiple image frames.

According to another embodiment of the present disclosure, an electronic device is disclosed, including a n image sensor, an illumination sensor, and at least one processor configured to: determine a photographic condition and select a number of photographic captures to be executed in a multi-image frame photographing mode based on the determined photographic condition, control the image sensor to capture multiple image frames based on the selected number of photographic captures, and generate an image having a predetermined image resolution from the captured multiple image frames.

According to another embodiment of the present disclosure, a non-transitory computer-readable medium storing a program executable by at least one processor of an electronic device is disclosed, executable to cause the electronic device to: determine, by the at least one processor, a photographic condition and selecting a number of photographic captures to be executed in a multi-image frame photographing mode based on the determined photographic condition, capture, by a camera, multiple image frames based on the number of photographic captures, and generate an image having a predetermined image resolution from the captured multiple image frames.

### BRIEF DESCRIPTION OF THE DRAWINGS

The present disclosure will be more apparent from the following detailed description taken in conjunction with the accompanying drawings, in which:

FIG. 1 illustrates a network environment including an electronic device according to various embodiments of the present disclosure;

FIG. 2 is a block diagram illustrating a configuration of an electronic device according to various embodiments of the present disclosure;

FIG. 3 is a flow chart illustrating a process of generating an image based on a multi-image frame photographing mode in an electronic device according to various embodiments of the present disclosure;

FIG. 4 is a flow chart illustrating a process of performing a multi-image frame photographing mode in an electronic device according to various embodiments of the present disclosure;

FIG. 5A and FIG. 5B are flow charts illustrating a process of performing a multi-image frame photographing mode based on diverse pieces of state information in an electronic device according to various embodiments of the present disclosure;

FIG. 6 is a flow chart illustrating a process of photographing an image depending on whether a flash function is used in an electronic device according to various embodiments of the present disclosure;

FIG. 7 is a flow chart illustrating a process of performing a correction depending on a illumination value of an image generated in an electronic device according to various embodiments of the present disclosure;

FIG. 8 illustrates the configuration of a table for determining the number of photographing frames utilized for an image correction in an electronic device according to various embodiments of the present disclosure;

FIG. 9 is a view illustrating a screen configuration for photographing an image in a multi-image frame photographing mode of an electronic device according to various embodiments of the present disclosure; and

FIG. 10A, FIG. 10B, FIG. 10C and FIG. 10D are views illustrating a screen configuration for performing an additional function in a multi-image frame photographing mode of an electronic device according to various embodiments of the present disclosure.

### DETAILED DESCRIPTION

Hereinafter, various embodiments of the present disclosure will be described with reference to the accompanying drawings.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications, equivalents, and/or alternatives within the present disclosure. In the description of the drawings, similar reference numerals may be used to designate similar elements.

As used in various embodiments of the present disclosure, the expressions “include”, “may include” and other conjugates refer to the existence of a corresponding disclosed function, operation, or constituent element, and do not limit one or more additional functions, operations, or constituent elements. Further, as used in various embodiments of the present disclosure, the terms “include”, “have”, and their conjugates are intended merely to denote a certain feature, numeral, step, operation, element, component, or a combination thereof, and should not be construed to initially exclude the existence of or a possibility of addition of one or more other features, numerals, steps, operations, elements, components, or combinations thereof.

Further, as used in various embodiments of the present disclosure, the expression “or” includes any or all combinations of words enumerated together. For example, the expression “A or B” or “at least A or/and B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, without departing from the present disclosure, a first component element may be named a second component element. Similarly, the second component element also may be named the first component element.

When an element is referred to as being “coupled” or “connected” to any other element, it should be understood that not only the element may be coupled or connected directly to the other element, but also a third element may be interposed therebetween. Contrarily, when an element is referred to as being “directly coupled” or “directly connected” to any other element, it should be understood that no element is interposed therebetween.

The terms as used in various embodiments of the present disclosure are used merely to describe a certain embodiment and are not intended to limit the present disclosure. As used herein, singular forms may include plural forms as well unless the context explicitly indicates otherwise. Furthermore, all terms used herein, including technical and scientific terms, have the same meaning as commonly understood by those of skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to various embodiments of the present disclosure may be a device including an image sensor. The electronic device according to various embodiments of the present disclosure may, for example, include at least one of a smart phone, a tablet personal compute r(PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mount-device (HMD) such as electronic glasses, electronic clothing, an electronic bracelet, an electronic necklace, an electronic appcessory, an electronic tattoo, or a smart watch), a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an artificial intelligence robot, a Television (TV), an electronic dictionary, an electronic key, a camcorder, medical equipment (e.g., a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), a vehicle infotainment device, electronic equipment for a ship (e.g., ship navigation equipment and a gyrocompass), avionics, security equipment, an industrial or home robot, a part of furniture or building/structure, an electronic board, an electronic signature receiving device, a projector, and various measuring instruments (e.g., a water meter, an electricity meter, a gas meter, or a wave meter), each of which includes An electronic device according to embodiments of the present disclosure may be a device including a communication function. The electronic device according to various embodiments of the present disclosure may be a combination of one or more of the aforementioned various devices. Further, the electronic device according to various embodiments of the present disclosure may be a flexible device. Further, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

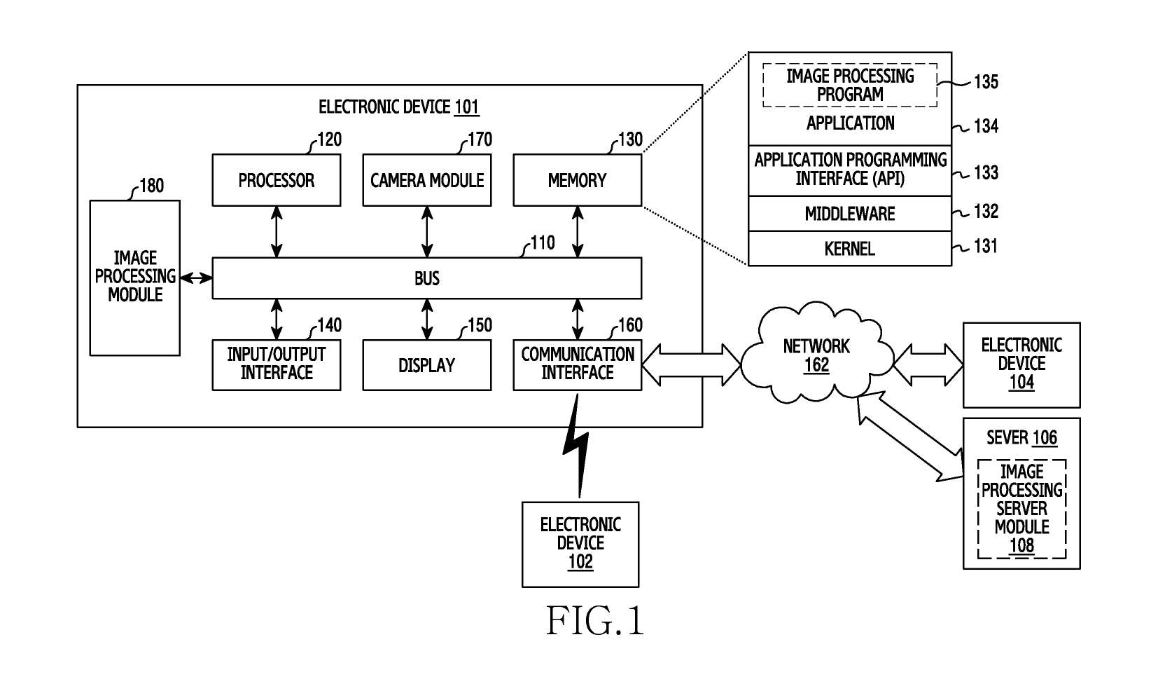

FIG. 1 illustrates a network environment including an electronic device according to various embodiments of the present disclosure.

Referring to FIG. 1, an electronic device 101 may include at least one of a bus 110, a processor 120, a memory 130, an input/output interface 140, a display 150, a communication interface 160, a camera module 170, or an image processing module 180.

The bus 110 may be a circuit that connects the aforementioned elements to each other and transmits communication signals (e.g., control messages) between the aforementioned elements.

The processor 120 may, for example, receive a command from other aforementioned elements (e.g., the memory 130, the input/output interface 140, the display 150, the communication interface 160, the camera module 170, or the image processing module 180), through the bus 110, may decrypt the received command, and may execute calculation or data processing depending on the decrypted command.

The processor 120 may be included in the electronic device 101 to perform a predetermined function of the electronic device 101. According to an embodiment, the processor 120 may include one or more Application Processors (APs) and one or more Micro Controller Units (MCUs).

The APs may drive an operating system or an application program (or application) to control a plurality of hardware or software elements connected thereto, and may process various types of data including multimedia data and perform calculations. The APs may be implemented by, for example, a System on Chip (SoC). According to an embodiment, the processor 210 may further include a Graphic Processing Unit (GPU) (not illustrated).

The MCUs may be a processor configured to perform a predetermined operation. According to an embodiment, the MCU may obtain sensing information through one or more designated motion sensors (for example, a gyro sensor, an acceleration sensor, or a geomagnetic sensor), may compare obtained sensing information, and may determine a motion state of a designated sensor with reference to a database of the electronic device 101.

According to an embodiment, the AP or the MCU may load a command or data received from at least one of a non-volatile memory or other elements connected to each of the AP and the MCU in a volatile memory, and may process the loaded command or data. Furthermore, the APs or the MCUs may store data received from or generated by at least one of the other elements in a non-volatile memory.

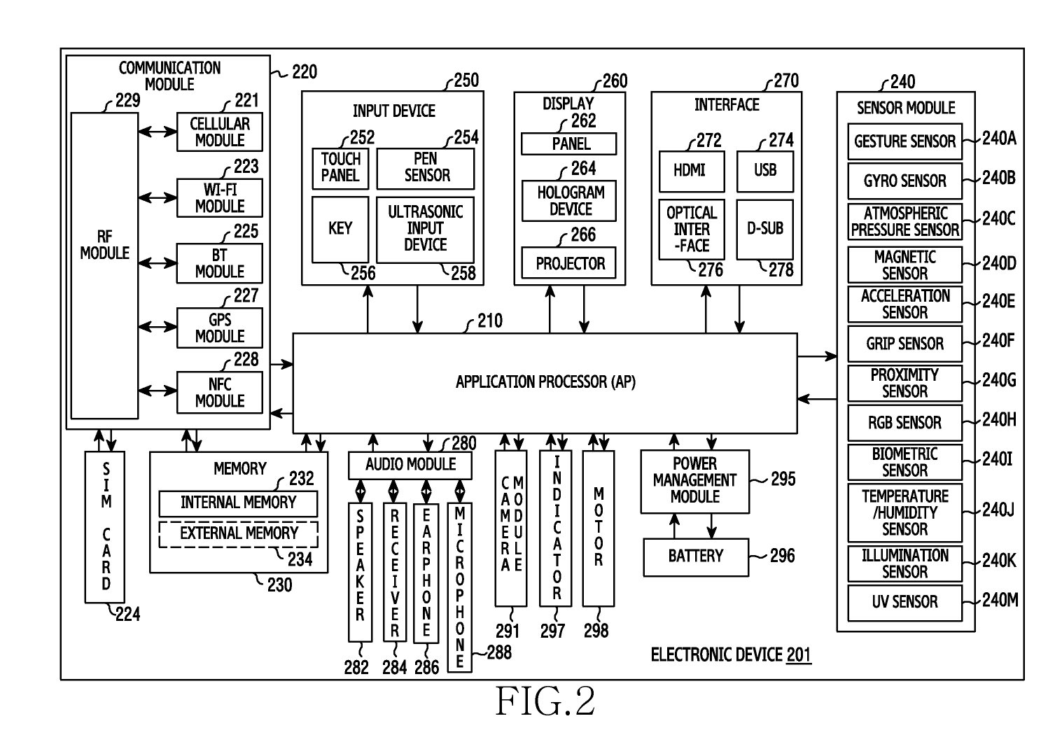

The memory 130 (e.g., a memory 230 in FIG. 2) may store a command or data received from the processor 120 or other component elements (e.g., the input/output interface 140, the display 150, the communication interface 160, the camera module 170, or the image processing module 180), or generated by the processor 120 or other component elements. The memory 130 may include programming modules, for example, a kernel 131, middleware 132, an application programming interface (API) 133, an application 134, and the like. Each of the programming modules may be formed of software, firmware, or hardware, or a combination of two or more thereof.

The kernel 131 may control or manage the system resources (e.g., the bus 110, the processor 120, and the memory 130) used to execute operations or functions implemented in the remaining other programming modules, for example, the middleware 132, the API 133, and the applications 134. Also, the kernel 131 may provide an interface to the middleware 132, the API 133, or the application 134, so as to access each component element of the electronic device 101 for controlling or managing.

The middleware 132 may act as an intermediary so as to allow the API 133 or the application 134 to communicate with and exchange data with the kernel 131. Further, for operation requests received from the application 134, the middleware 132 may control the operation requests (for example, perform scheduling or load balancing) by using, for example, a method of prioritizing at least one of the applications 134 in using system resources (for example, the bus 110, the processor 120, the memory 130, or the like) of the electronic device 101.

The API 133 is an interface used by the application 134 to control a function provided from the kernel 131 or the middleware 132, and may include, for example, at least one interface or function (for example, an instruction) for a file control, a window control, image processing, a character control, or the like.

The applications 134 (or processor) may include a short message service (SMS)/multimedia message service (MMS) application, an e-mail application, a calendar application, an alarm application, a health care application (e.g., application for monitoring physical activity or blood glucose), and an environmental information application (e.g., application for providing atmospheric pressure, humidity, or temperature information). The applications (or processors) 134 may correspond to an application associated with information exchange between the electronic device 101 and an external electronic device (e.g. the electronic device 102 or the electronic device 104). The application associated with exchanging information may include, for example, a notification relay application for transferring predetermined information to an external electronic device or a device management application for managing an external electronic device. The notification relay application may, for example, include a function of transferring, to an external electronic device (e.g., the electronic device 104), notification information generated by other applications (e.g., an SMS/MMS application, an e-mail application, a health management application, or an environmental information application) of the electronic device 101. Additionally or alternatively, the notification relay application may receive notification information from, for example, the external electronic device (e.g., the electronic device 104) and provide the received notification information to a user. For example, the device management application may manage (e.g., install, delete, or update) functions for at least a part of the external electronic device (e.g., the electronic device 104) communicating with the electronic device 101 (e.g., turning on/off the external electronic device itself (or some elements thereof) or adjusting brightness (or resolution) of a display), applications operating in the external electronic device, or services (e.g., a telephone call service or a message service) provided from the external electronic device. According to various embodiments, the applications 134 may include an application designated according to the attribute (e.g., the type) of the external electronic device (e.g., the electronic device 102 or 104). For example, when the external electronic device is an MP3 player, the application 134 may include an application related to the reproduction of music. Similarly, in the case where the external electronic device is a mobile medical appliance, the application 134 may include an application related to health care. According to an embodiment, the application 134 may include at least one of an application designated to the electronic device 101 or an application received from the external electronic device (e.g., a server 106 or the electronic device 104).

An image processing program 135 may be provided by being included in the application 134, or may be stored in the memory 130 as a separate program.

According to various embodiments, the image processing program 135 may determine a multi-image frame photographing mode, determine a photographing condition including the number of times in which an image frame is photographed, and generate an image of designated resolution based on multiple image frames obtained according to the determined photographing condition. Herein, the multi-image frame photographing mode may be abbreviated to a multi frame photographing mode.

According to an embodiment, the image processing program 135 may determine the multi-image frame photographing mode based on illumination around the electronic device 101 or object illumination. According to an embodiment, the image processing program 135 may determine the multi-image frame photographing mode when a value of illumination around the electronic device 101 or object illumination is less than or equal to a designated illumination value.

According to an embodiment, the image processing program 135 may determine the multi-image frame photographing mode based on a magnification of a digital zoom. According to an embodiment, the image processing program 135 may include at least one of resolution, a shutter speed, and a size of an image frame as a photographing condition.

According to an embodiment, the image processing program 135 may apply a super resolution technique to multiple image frames and then generate an image of a designated resolution. According to an embodiment, the image processing program 135 may apply a low illumination image processing (low light shot) technique to multiple image frames and then generate an image of a designated resolution.

According to an embodiment, the image processing program 135 may display, on the electronic device 101, whether the multi-image frame photographing mode is used. According to an embodiment, the image processing program 135 may determine a photographing condition based on at least one among whether an anti-shake correction function is used, a magnification of a digital zoom, or whether a flash function is used. According to an embodiment, the image processing program 135 may obtain at least a part of characters, symbols, numbers, and character strings which are included in an obtained image, by using an optical character reading technique.

According to various embodiments, the image processing program 135 may detect illumination (illumination around the electronic device 101 or object illumination) or a magnification of a digital zoom to enter into a low illumination image processing mode or a digital zoom image processing mode, and determine the number of image frames to be used in the low illumination image processing mode or the digital zoom image processing mode according to a detected illumination value or a detected digital zoom magnification value. According to an embodiment, the image processing program 135 may determine the number of the image frames to be inversely proportion to the detected illumination value according to an increase of the detected illumination value. According to an embodiment, the image processing program 135 may determine the number of the image frames to be proportion to the digital zoom magnification value according to an increase of the digital zoom magnification value. According to an embodiment, the image processing program 135 may determine the number of image frames by further considering whether the hand-shack correction function or the flash function is used. According to an embodiment, the image processing program 135 may determine the number of image frames to be reduced when the optical anti-shake correction function is used. According to an embodiment, the image processing program 135 may process multiple image frames to be obtained according to the number of the determined image frames when entering into the low illumination image processing mode, and synthesize (e.g., combine, merge, or correct) the multiple obtained image frames so that at least one image in which resolution is corrected may be generated. Then, when resolution of the generated image is satisfied with a designated numerical value, the image processing program 135 may apply a post-processing technique to the generated image. Further, the image processing program 135 may process a text included in at least a part of the generated image to be obtained. According to an embodiment, the image processing program 135 may process the obtained text to be transmitted to another designated electronic device through the communication interface 160.

According to various embodiments, the electronic device 101 may include a device which performs an operation for a whole or a part of the image processing program 135 and is configured by a module (e.g., the image processing module 180).

The image processing program 135 may provide a high-resolution image processing scheme as the electronic device 101 photographs an image through the camera module 170. The high-resolution image processing scheme (or technique), in photographing an image, includes a specific area (e.g., an image frame corresponding to an area in a state zoomed in based on a user input) among image areas which are photographed through the camera module 170 and then photographs an identical or similar image frame (e.g., an image frame in a state of maintaining an identical or similar structure) so that the high-resolution image processing scheme may be a method of correcting an image quality (or resolution) of an image area selected based on the photographed image. Herein, the image frame may express an image which is used in a process in which the electronic device 101 generates image data through the camera module 170. For example, the image processing program 135 may provide a program processing the electronic device 101 to obtain multiple image frames through the camera module 170 and provide a program which generates an image by combining, merging, or correcting the multiple image frames. The image processing program 135 may determine the number of image frames which are photographed according to a magnification of a digital zoom or control a shutter speed when the digital zoom is used in the electronic device 101. An embodiment of the high-resolution image processing scheme may correspond to an image processing technique of a Super Resolution (SR) scheme.

The image processing program 135 may provide a low illumination image processing scheme as the electronic device 101 photographs an image through the camera module 170. The low illumination image processing scheme (or technique) may, in photographing an image, be a method of photographing an image frame identical or similar to an initial image frame (e.g., an image frame in a state of maintaining an identical or similar structure) when an object illumination of an image frame photographed through the camera module 170 is not satisfied with a designated numerical value (e.g., when the object illumination is lower than the designated numerical value) so that a noise of the image is removed based on the photographed image or a resolution or a brightness of the image is corrected. The image processing program 135 may, when an object illumination is measured in the electronic device 101, determine the number of image frames which are photographed according to the measured illumination value or control a shutter speed. An embodiment of the low light image processing scheme may correspond to an image processing technique according to a low illumination image processing (Low Light Shot, LLS) scheme.

The embodiment has been described about the illumination measured in the electronic device 101, but it is not limited thereto. A resolution and contrast (difference or contrast of a brightness and darkness in an image frame) of a photographed image frame or generated image may be substituted for the illumination.

The input/output interface 140 may transfer instructions or data, input from a user through an input/output device (e.g., various sensors, such as an acceleration sensor or a gyro sensor, and/or a device such as a keyboard or a touch screen), to the processor 120, the memory 130, or the communication interface 160, for example, through the bus 110. For example, the input/output interface 140 may provide the processor 120 with data on a user's touch input through a touch screen. Furthermore, the input/output interface 140 may output instructions or data, received from, for example, the processor 120, the memory 130, or the communication interface 160 via the bus 110, through an output unit (e.g., a speaker or the display 150). For example, the input/output interface 140 may output voice data processed by the processor 120 to a user through a speaker.

The display 150 may display various pieces of information (for example, multimedia data or text data) to a user. Further, the display 150 may be configured by a touch screen which inputs a command by touching or proximity-touching an input means on the display.

The communication interface 160 (for example, a communication module 220 in FIG. 2) may establish a communication connection between the electronic device 101 and an external device (for example, the electronic device 104 or the server 106). For example, the communication interface 160 may be connected to the network 162 through wireless communication or wired communication, and may communicate with an external device. The wireless communication may include at least one of, for example, Wi-Fi, Bluetooth (BT), Near Field Communication (NFC), Global Positioning System (GPS) and cellular communication (e.g., LTE, LTE-A, CDMA, WCDMA, UMTS, WiBro, GSM, etc.). Also, the wired communication may include at least one of, for example, a Universal Serial Bus (USB), a High Definition Multimedia Interface (HDMI), Recommended Standard 232 (RS-232), and a Plain Old Telephone Service (POTS).

The camera module 170 may include an optical unit, a motion detection sensor (motion sensor), image sensor (not shown), or the like and may be configured by a module such as a motion detection module, a camera module, or the like. The optical unit may be driven by a mechanical shutter, a motor, or an actuator and may perform a motion such as a zoom function and an operation such as focusing by the actuator. The optical unit photographs surrounding objects and the image sensor detects the image photographed by the optical unit, thereby converting the photographed image into an electronic signal. Herein, the camera module 170 may be a sensor such as a Complementary Metal Oxide Semiconductor (CMOS) or a Charged Coupled Device (CCD) and may further use another image sensor of high resolution. The camera module 170 may embed a global shutter. The global shutter may perform a function similar to a mechanical shutter embedded in a sensor. A motion detection device (not shown) or a depth detection device (a depth sensor) may recognize a 3D operation of an object in a 3 dimensional (3D) space where the object is located. In a characteristic of a device which recognizes a motion of the object, a mechanical scheme, a magnetic scheme, an optical scheme, and an infrared scheme may be used. The motion detection device may be included in the camera module 170. The camera module 170 may provide an anti-shake correction function in photographing an image. When the electronic device 101 photographs an image through the camera module 170, the anti-shake correction function may prevent a quality of an image such as a focus or definition of an image photographed by a vibration generated in the electronic device 101 from being degraded. The anti-shake correction function may be provided as an electronic anti-shake correction function or an optical anti-shake correcting function. The optical anti-shake correction function may be classified with a lens shift scheme or an image sensor shift scheme.

According to an embodiment, the network 162 may be a communication network. The communication network may include at least one of a computer network, the Internet, the Internet of things, or a telephone network. According to an embodiment, at least one of the application 134, the application programming interface 133, the middleware 132, the kernel 131, or the communication interface 160 may support a protocol (for example, transport layer protocol, data link layer protocol, or physical layer protocol) for communication between the electronic device 101 and an external device.

According to an embodiment, the server 106 may support the driving of the electronic device 101 by performing at least one of the operations (or function) implemented by the electronic device 101. For example, the server 106 may include a server module (e.g., a server controller or a server processor) which can support a processor 120 or a specific module which makes a control to perform various embodiments of the present disclosure described below in the electronic device 101. For example, the server module may include at least one element of the processor 120 or the specific module to perform (e.g., act) at least one operation of the operations performed by the processor 120 or the specific module. According to various embodiments, the server module may be represented as the image processing server module 108 of FIG. 1.

FIG. 2 is a block diagram illustrating a configuration of an electronic device according to various embodiments.

The electronic device 201 may include, for example, the entirety or a part of the electronic device 101 illustrated in FIG. 1, or may expand all or some configurations of the electronic device 101. Referring to FIG. 2, the electronic device 201 may include at least one processor 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, or a motor 298.

At least one processor 210 may be included in the electronic device 101 to perform a predetermined function of the electronic device 101. According to an embodiment, the processor 210 may include one or more Application Processors (APs) and one or more Micro Controller Units (MCUs). According to another embodiment, the processor 210 may include one or more microcontrollers as an application or be functionally connected to the one or more microcontrollers. The APs may drive an operating system or an application program (or application) to control a plurality of hardware or software elements connected thereto, and may process various types of data including multimedia data and perform calculations. The APs may be implemented by, for example, a System on Chip (SoC). According to an embodiment, the processor 210 may further include a Graphic Processing Unit (GPU) (not illustrated).

The MCUs may be a processors configured to perform a predetermined operation. According to an embodiment of the present disclosure, the MCU may obtain sensing information through one or more designated motion sensors (for example, a gyro sensor, an acceleration sensor, or a geomagnetic sensor), may compare obtained sensing information, and may determine a motion state of a designated sensor (e.g., an earth magnetic sensor) with reference to a database of the electronic device 101.

According to an embodiment, the AP or the MCU may load a command or data received from at least one of a non-volatile memory or other components connected to each of the AP or the MCU in a volatile memory, and may process the loaded command or data. Furthermore, the APs or the MCUs may store data received from or generated by at least one of the other elements in a non-volatile memory.

The communication module 220 (e.g., the communication interface 160) may perform data transmission/reception in communication between the electronic device 101 and the other electronic devices (e.g., the electronic device 102 or 104, or the server 106) connected thereto through a network. According to an embodiment, the communication module 220 may include a cellular module 221, a Wi-Fi module 223, a BT module 225, a GPS module 227, an NFC module 228, and a Radio Frequency (RF) module 229.

The cellular module 221 may provide a voice call service, a video call service, a text message service, or an Internet service through a communication network (e.g., Long Term Evolution (LTE), LTE-A, Code Division Multiple Access (CDMA), Wideband CDMA (WCDMA), Universal Mobile Telecommunication System (UMTS), Wireless Broadband (WiBro), or Global System for Mobile communication (GSM)). Furthermore, the cellular module 221 may distinguish and authenticate electronic devices within a communication network using, for example, a subscriber identification module (e.g., the SIM card 224). According to an embodiment, the cellular module 221 may perform at least some of the functions that the AP 210 may provide. For example, the cellular module 221 may perform at least some of the multimedia control functions.

According to an embodiment, the cellular module 221 may include a communication processor (CP). Further, the cellular module 221 may be implemented by, for example, an SoC. Although the elements such as the cellular module 221 (e.g., a communication processor), the memory 230, and the power management module 295 are illustrated to be separate from the AP 210 in FIG. 2, the AP 210 may include at least some of the aforementioned elements (e.g., the cellular module 221) according to an embodiment.

According to an embodiment, the AP 210 or the cellular module 221 (for example, the CP) may load instructions or data received from at least one of a non-volatile memory or other components connected thereto into a volatile memory and process the loaded instructions or data. Furthermore, the AP 210 or the cellular module 221 may store data received from or generated by at least one of the other elements in a non-volatile memory.

The Wi-Fi module 223, the BT module 225, the GPS module 327, and the NFC module 228 may include a processor for processing data transmitted/received through the corresponding module. In FIG. 2, the cellular module 221, the Wi-Fi module 223, the BT module 225, the GPS module 227, and the NFC module 228 are illustrated as separate blocks. However, according to an embodiment, at least some (e.g., two or more) of the cellular module 221, the Wi-Fi module 223, the BT module 225, the GPS module 227, and the NFC module 228 may be included in one Integrated Chip (IC) or one IC package. For example, at least some (for example, the communication processor corresponding to the cellular module 221 and the Wi-Fi processor corresponding to the Wi-Fi module 223) of the processors corresponding to the cellular module 221, the Wi-Fi module 223, the BT module 225, the GPS module 227, and the NFC module 228 may be implemented as one SoC.

The RF module 229 may transmit/receive data, for example, RF signals. Although not illustrated in the drawing, the RF module 229 may, for example, include a transceiver, a Power Amp Module (PAM), a frequency filter, a Low Noise Amplifier (LNA), or the like. In addition, the RF module 229 may further include an element for transmitting/receiving electronic waves over free air space in wireless communication, for example, a conductor, a conducting wire, or the like. In FIG. 2, the cellular module 221, the Wi-Fi module 223, the BT module 225, the GPS module 227, and the NFC module 228 share one RF module 229 each other. However, according to an embodiment, at least one of them may transmit/receive an RF signal through a separate RF module.

The SIM card 224 may be a card including a subscriber identification module, and may be inserted into a slot formed in a predetermined location of the electronic device. The SIM card 224 may include unique identification information (e.g., an integrated circuit card identifier (ICCID)) or subscriber information (e.g., an international mobile subscriber identity (IMSI)).

The memory 230 (e.g., the memory 130) may include an internal memory 232 or an external memory 234. The internal memory 232 may include at least one of a volatile memory (e.g., a Dynamic Random Access Memory (DRAM), a Static RAM (SRAM), a Synchronous Dynamic RAM (SDRAM), or the like) or a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 234 may be functionally connected to the electronic device 201 through various interfaces. According to an embodiment, the electronic device 201 may further include a storage device (or storage medium) such as a hard disc drive.

The sensor module 240 may measure a physical quantity or sense an operating state of the electronic device 201, and may convert the measured or sensed information into an electric signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., red, green, and blue (RGB) sensor), a biometric sensor 240I, a temperature/humidity sensor 240J, an light sensor 240K, and a Ultra Violet (UV) sensor 240M. Additionally or alternatively, the sensor module 240 may, for example, include an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), a fingerprint sensor (not shown), and the like. The sensor module 240 may further include a control circuit for controlling one or more sensors included therein.

The input device 250 may include a touch panel 252, a (digital) pen sensor 254, a key 256, or an ultrasonic input device 258. The touch panel 252 may detect a touch input in at least one of, for example, a capacitive type, a resistive type, an infrared type, and an acoustic wave type. The touch panel 252 may further include a control circuit. In case of the capacitive type touch panel, physical contact or proximity detection is possible. The touch panel 252 may further include a tactile layer. In this case, the touch panel 252 may provide a user with a tactile reaction.

The (digital) pen sensor 254 may be implemented, for example, using the same or a similar method to receiving a user's touch input or using a separate sheet for detection. The key 256 may include, for example, a physical button, an optical key, or a keypad. The ultrasonic input device 258 may identify data by detecting an acoustic wave with a microphone (e.g., a microphone 288) of the electronic device 201 through an input unit generating an ultrasonic signal, and may perform wireless detection. According to an embodiment, the electronic device 201 may also receive a user input from an external device (e.g., a computer or server) connected thereto using the communication module 220.

The display 260 (e.g., the display 150) may include a panel 262, a hologram device 264, or a projector 266. The panel 262 may be, for example, a Liquid Crystal Display (LCD), an Active Matrix Organic Light Emitting Diode (AM-OLED), or the like. The panel 262 may be implemented to be, for example, flexible, transparent, or wearable. The panel 262 may be formed as a single module together with the touch panel 252. The hologram device 264 may show a three dimensional image in the air using an interference of light. The projector 266 may display an image by projecting light onto a screen. The screen may be located, for example, in the interior of or on the exterior of the electronic device 201. According to an embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 160 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert a sound and an electrical signal. At least some elements of the audio module 280 may be included in, for example, the input/output interface 140 illustrated in FIG. 1. The audio module 280 may process voice information input or output through, for example, a speaker 282, a receiver 284, earphones 286, or the microphone 288. The camera module 291 is a device for capturing still and moving images, and may include one or more image sensors (e.g., a front sensor or a rear sensor), a lens (not illustrated), an image signal processor (ISP, not illustrated), or a flash (e.g., an LED or a xenon lamp, not illustrated) according to an embodiment.

The power management module 295 may manage the power of the electronic device 201. Although not illustrated, the power management module 295 may include, for example, a Power Management Integrated Circuit (PMIC), a charger Integrated Circuit (IC), or a battery or fuel gauge. According to various embodiments, the PMIC may be mounted to an integrated circuit or an SoC semiconductor. The charging methods may be classified into wired charging and wireless charging. The charger IC may charge a battery and may prevent an overvoltage or excess current from being induced or flowing from a charger.

According to an embodiment, the charger IC may include a charger IC for at least one of the wired charging or the wireless charging. The wireless charging method may include, for example, magnetic resonance charging, magnetic induction charging, and electromagnetic charging, and an additional circuit for the wireless charging such as a coil loop, a resonance circuit, a rectifier or the like may be added.

The battery gauge may measure, for example, a residual quantity of the battery 296, and a voltage, a current, or a temperature while charging. The battery 296 may store or generate electricity and may supply power to the electronic device 201 using the stored or generated electricity. The battery 296 may include, for example, a rechargeable battery or a solar battery.

The indicator 297 may display a specific state of the electronic device 201 or a part thereof (e.g., the AP 210), for example, a boot-up state, a message state, or a state of charge (SOC). A motor 298 may convert an electrical signal into a mechanical vibration. Although not illustrated, the electronic device 201 may include a processing device (e.g., a GPU) for supporting mobile TV. The processing device for supporting mobile TV may process, for example, media data pursuant to a certain standard of Digital Multimedia Broadcasting (DMB), Digital Video Broadcasting (DVB), or media flow.

Each of the above described elements of the electronic device according to various embodiments of the present disclosure may include one or more components, and the name of a corresponding element may vary according to the type of electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

According to various embodiments, the electronic device 101 may photograph an image in diverse photographing schemes through the camera module 170 and/or may process (e.g., photograph and then process) an image photographed through the processor 120 (and/or an image processing processor). The electronic device 101 controls the photographing schemes or processes the photographed image so that a noise of an image can be reduced or a quality of an image can be improved. According to an embodiment, when photographing an image corresponding to a photographing angle of the camera module 170 through the camera module 170, the electronic device 101 considers state information (e.g., low illumination object photographing or digital zoom photographing) of the electronic device 101 so that a photographing condition of the camera module 170 according to a photographing situation can be determined. According to an embodiment, the electronic device 101 may determine a photographing condition with reference to measurement information through a movement sensor (e.g., a slope sensor, a gyroscope, an accelerometer sensor, or the like) included in the electronic device 101, such as an illumination measured in the electronic device 101, a temperature of the electronic device 101 or a surrounding temperature of the electronic device 101, an acceleration or a slope of the electronic device 101, state information of the electronic device 101 such as a temperature and/or battery information (e.g., the remaining amount information of the battery) of the camera module 170, whether a zoom function (e.g., a digital zoom) of the camera module 170 exists, whether an anti-shake correction (e.g., optical anti-shake correction or digital anti-shake correction) function exists, whether a flash function exists, a kind of objects detected from the camera module 170, and/or state information of the camera module 170, such as an illumination measured in the camera module 170. Herein, although the state information of the electronic device 101 and the state information of the camera module 170 are distinguished from each other in the above description, the camera module 170 may be a module which is included in the electronic device 101 or is connected to the electronic device 101. Hereinafter, the camera module 170 may represent the state information of the electronic device 101 (or the state information). The electronic device 101 may perform a multi-image frame photographing mode which controls the number of frames of an image photographed based on at least one of the state information. Since the electronic device 101 performs the multi-image frame photographing mode, when an image is photographed through the camera module 170, two or more photographed image frames may be photographed and one image (or two or more synthesized images) may be generated based on the multiple photographed image frames. The electronic device 101 may control (e.g., control a shutter speed) exposure of the camera module 170 which photographs a frame in performing the multi-image frame photographing mode. Further, the electronic device 101 may determine a resolution of an image frame which photographs in the multi-image frame photographing mode through the camera module 170 and may determine a resolution of an image generated based on the image frame. The electronic device 101 may perform two or more photographing conditions together in determining the photographing conditions such as the multi-image frame photographing mode, an exposure control such as a shutter speed, or a resolution determination.

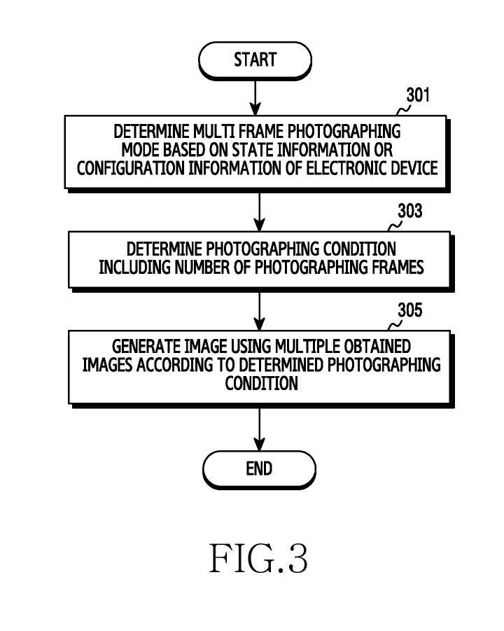

FIG. 3 is a flow chart illustrating a process of generating an image based on a multi-image frame photographing mode in an electronic device according to various embodiments of the present disclosure.

Referring to FIG. 3, in operation 301, an electronic device 101 may determine whether a multi-image frame photographing mode is to be used based on state information and/or configuration information of the electronic device 101. For example, the state information of the electronic device 101 may be a surrounding environmental illumination for the electronic device 101 or illumination of an object to be captured. The configuration information may be information configured based on a user input, such as whether a zoom function is active, whether a hand-shack correction function is active, and whether a flash function is active, where the functions are configured for use with and in the electronic device 101. According to an embodiment, the electronic device 101 may identify an illumination value measured in the camera module 170. The electronic device 101 may determine or detect the photographing condition of the electronic device 101 as the multi-image frame photographing mode when the identified illumination value is less than a designated numerical value. The electronic device 101 may measure illumination by a light-amount detected through the camera module 170 and may measure illumination through an illumination sensor included in the electronic device 101. Moreover, the electronic device 101 may determine a multi frame photographing condition based on an illumination value and also determine or detect the multi frame photographing condition with reference to at least one of one various pieces of state information or configuration information of the electronic device 101. For example, the electronic device 101 may determine the multi-image frame photographing mode based on whether the digital zoom is used (e.g., whether the digital zoom is used).

In operation 303, the electronic device 101 may determine a photographing condition including the number of photographing image frames (e.g., photographing frame) to be captured in the multi-image frame photographing mode. The photographing condition may include the number of image frames to be photographed, resolution of an image frame, or a shutter speed of the camera module 170 for photographing an image frame. According to an embodiment, the electronic device 101 may determine the number of times in which the image frame is photographed, based on the state information, configuration information, or a user input of the electronic device 101. According to an embodiment, the electronic device 101 may determine the number of times in which the image frame is photographed, based on the measured illumination value. For example, as the measured illumination value decreases, a quality of an obtained image frame (e.g., definition, contrast, and brightness) may be degraded, and the occurrence visual noise may be increased in any resulting captured image. Therefore, the electronic device 101 may photograph or capture a quantity of frames larger than the number of frames captured having a high illumination, in order to generate (e.g., through a composition) at least one image based on the obtained image frame.

According to another embodiment, the electronic device 101 may determine the number of times in which an image frame is photographed based on a magnification of the digital zoom when the digital zoom is used. For example, as a measured magnification of the digital zoom increases, an image quality of a captured digital zoom area may be degraded, and the occurrence of visual noise may increase. Therefore, the electronic device 101 may photograph more frames in comparison with a case of using a digital zoom of a low magnification in order to generate (e.g., generate an image through a synthesis) at least one image based on the obtained image frame.

According to another embodiment, the electronic device 101 may determine or detect a resolution of an image frame photographed in a photographing condition or resolution of an image generated based on the obtained image frame. For example, the electronic device 101 may configure an image frame to have a resolution of 2560*1600, for synthesizing multiple image frames, and then generate a high-quality image corresponding to a lower resolution of 1920*1080. The electronic device 101 may also configure the image to have a resolution which is identical to the resolution of the generated image or an image having low resolution, to be photographed. According to an embodiment, it is not limited that, in determining a photographing condition, the electronic device 101 determines the number of times in which the image frame is photographed, resolution of an image frame to be photographed, or resolution of an image generated based on an obtained image frame, and a photographing condition such as a size of a shutter speed image frame or a size of an image to be generated may be additionally determined.

Further, the electronic device 101 may determine a photographing condition based on an object detected through the camera module 170. According to an embodiment, the electronic device 101 may change the photographing condition when an outline of an object displayed on the display 150 is clearly not identified through the camera module 170. For example, the electronic device 101 may rapidly change the shutter speed and may increase the number of times in which an image frame is photographed. The electronic device 101 may increase definition of an image by rapidly configuring the shutter speed or may provide various sources when image frames are synthesized, by configuring an increase in the number of times in which the image frame is to be photographed.

In operation 305, the electronic device 101 may generate at least one image with multiple images captured according to the determined photographing condition. The electronic device 101 may obtain the multiple images by photographing the multiple image frames according to the determined photographing condition. The electronic device 101 may use a method of synthesizing the multiple image frames as a method for generating at least one image. The electronic device 101 may use a low illumination image processing technique which can correct resolution, e.g., brightness, contrast, light and darkness, or the like of the generated image or reduce a noise of the generated image, as the method of synthesizing the multiple images. The electronic device 101 may use a high-resolution image processing technique which can correct resolution of an image or a quality corresponding to the resolution. For example, the electronic device 101 may improve a quality of an image using a post-processing technique such as a retouching when measured illumination is not satisfied with a designated numerical value or the quality of the image is degraded in accordance with the designated resolution. Herein, the post-processing technique such as a retouching may use a scheme of applying an effect (hereinafter, post-processing technique) such as face recognition, whitening, smoothing, and sharpening.

Therefore, in photographing an image, the electronic device 101 may perform a correction scheme for obtaining an image with reduced visual noise than a designated numerical value during low illumination photographing. The electronic device 101 may generate an image using a low illumination image processing mode in the multiple image frames when the measured illumination is lower than (e.g., is less than, or is less than or equal to) the designated numerical value. For example, the electronic device 101 may combine, merge, or correct multiple photographed image frames in generating an image in the low illumination image processing scheme. The electronic device 101 may increase resolution of an image and adjust a condition such as brightness, contrast, light and darkness, in combining, merging, or correcting the obtained frames.

According to an embodiment, the electronic device 101 may cause degradation of a quality such as resolution of the obtained image or generate a noise in the image when a zoom function (e.g., a digital zoom function) is used. The electronic device 101 may perform a correction scheme for obtaining an image while maintaining a quality when using the digital zoom function. The electronic device 101 may generate an image using the high-resolution image processing mode which can maintain high-quality resolution when using the digital zoom function. According to an embodiment, the electronic device 101 may combine, merge or correct multiple photographed image frames. In obtaining multiple image frames, the electronic device 101 may obtain an image including a common screen area of an identical or similar photographing angle and may generate an image (or a high-quality image in accordance with designated resolution) corresponding to a high-resolution screen area based on a common screen area in each frame. Even though an image is photographed using the digital zoom, the electronic device 101 may generate an image with the low illumination image photographing technique when a measured illumination value is lower than a designated numerical value in the electronic device 101. The electronic device 101 may generate an enlarged image (e.g., a high-resolution image) using the high-resolution image processing scheme in accordance with a selected area by the digital zoom function after generating an image in a low illumination image generation scheme.

According to various embodiments, the method of obtaining an image of an electronic device may include an operation of determining a multi-image frame photographing mode, an operation of determining a photographing condition including the number of times in which an image frame is photographed, and an operation of generating a designated resolution image based on multiple image frames obtained according to the photographing condition. According to an embodiment, in determining the multi-image frame photographing mode, the multi-image frame photographing mode may be determined based on illumination around the electronic device or object illumination. According to an embodiment, in determining the multi-image frame photographing mode based on state information of the electronic device, when the illumination around the electronic device or an illumination value of object illumination is less than or equal to a designated illumination value, the multi-image frame photographing mode may be determined. According to an embodiment, the operation of determining the multi-image frame photographing mode may be determined based on a digital zoom magnification. According to an embodiment, a photographing condition may include at least one among resolution of an image frame, a shutter speed, and a size of an image frame. According to an embodiment, in generating the designated resolution image, the designated resolution image may be generated the designated resolution image by applying a super resolution technique to multiple image frames. According to an embodiment, in generating the designated resolution image, the designated resolution image may be generated the designated resolution image by applying a low illumination processing (low light shot) technique to multiple image frames. According to an embodiment, whether the multi-image frame photographing mode is being used may be displayed in the electronic device. According to an embodiment, in determining the photographing condition, photographing condition may be determined based on at least one among whether an anti-shake correction function is used, a magnification of a digital zoom, or whether a flash function is used. According to an embodiment, an operation of obtaining at least a part among a character, a symbol, a number, a character string which are included in the obtained image is further included and the at least a part may be obtained by applying an optical character reading technique.

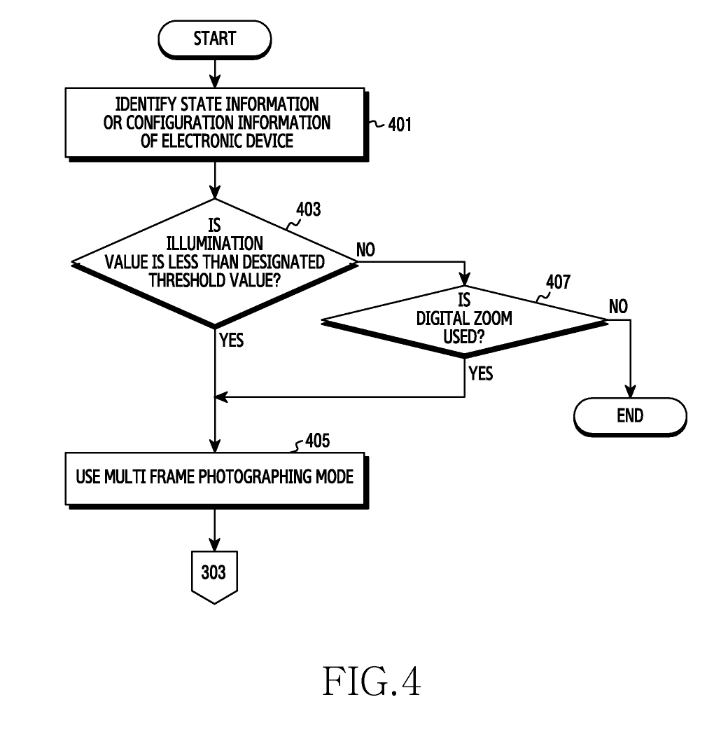

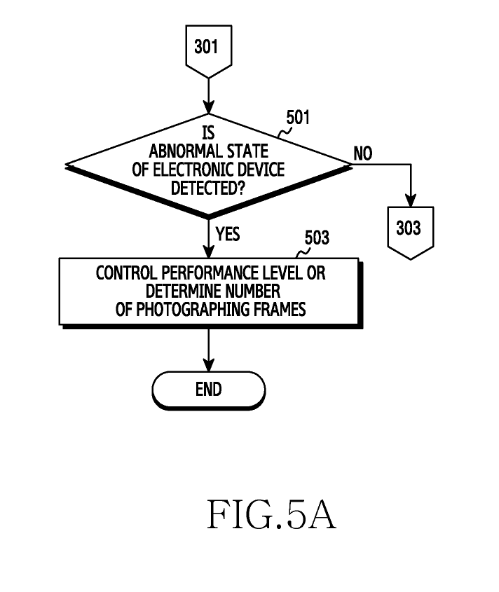

FIG. 4 is a flow chart illustrating a process of performing a multi-image frame photographing mode in an electronic device according to various embodiments of the present disclosure.

Referring to FIG. 4, in operation 401, an electronic device 101 may identify state information or configuration information of the electronic device 101. According to an embodiment, the electronic device 101 may identify the state information when a photographing program (e.g., the image processing program 135) is executed (e.g., when the image processing program 135 is installed or is firstly executed after the installation). For example, the electronic device 101 may obtain device identification information of the electronic device 101 or device identification information of the camera module 170, and may identify state information corresponding to the device identification information of the electronic device 101 or the device identification information of the camera module 170 based on a database (e.g., data of the memory 130 or the image processing program 135). In addition, the electronic device 101 may request the state information of the camera module 170 (or the state information of the electronic device 101) in the server 106 connected to the electronic device 101 with network communication based on the obtained device identification information of the camera module 170 (or the identification information of the electronic device 101).

In operation 403, the electronic device 101 may determine whether a measured illumination value is less than a designated numerical value (threshold value). In measuring illumination, the electronic device 101 may measure illumination of, for example, a surrounding environment by an amount of light detected through the image sensor, and may measure illumination through an illumination sensor included in the electronic device 101. Further, the electronic device 101 may identify resolution of a photographed image frame (e.g., an image frame obtained through preliminary photography. The electronic device 101 may execute a specific mode (e.g., the multi-frame photographing mode of operation 405) when the measured illumination is less than a designated numerical value (e.g., a value such as 600 lux or “lx”) and may perform operation 407 when the measured illumination is larger than the designated numerical value (e.g., 600 lx).

In operation 405, the electronic device 101 may perform the multi-image frame photographing mode based on the identified illumination value. When an image is photographed through the camera module 170 of the electronic device 101, the multi-image frame photographing mode may correspond to a mode in which two or more (multiple) image frames are obtained in accordance with a structure identical or similar to a structure of a photographing time point and a synthesis (e.g., at least one among combination, merge, and correction methods) of the obtained image frames may be used to generate at least one image.

When operation 405 is performed, the electronic device 101 may end the embodiment of FIG. 4 or may perform operation 303 of FIG. 3.

In operation 407, the electronic device 101 may determine whether a zoom function of the image sensor is used when the measured illumination value is larger than the designated numerical value. According to an embodiment, use of a zoom function (e.g., digital zoom) in the electronic device 101 may cause degradation of image quality, such as reduced resolution in the obtained image, or generated visual noise. The electronic device 101 may thus perform operation 405 when the zoom function is used, and may end the process embodiment of FIG. 4 when the zoom function is not used.

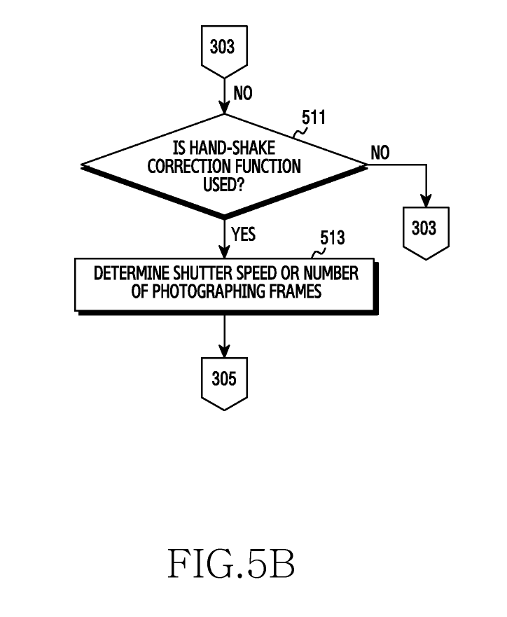

FIGS. 5A and 5B are flow charts illustrating a process of performing a multi-image frame photographing mode based on diverse pieces of state information in an electronic device according to various embodiments.

Hereinafter, various embodiments of FIG. 5A will be described. Referring to FIG. 5A, the electronic device 101 may describe a flow of an operation performed when detecting an abnormal state of the electronic device 101 in a multi-image frame photographing mode.

In operation 501, the electronic device 101 may detect an abnormal state of the electronic device 101 during execution of the multi-image frame photographing mode. For example, the electronic device 101 may overheat one of the modules, such as the processor 120, the memory 130, and the camera module 170 while executing the image processing program 135 or another program. The electronic device 101 may thus detect that a module has overheated when, for example, a temperature of one of the modules exceeds a threshold temperature during an operation of the multi frame photographing mode.

According to another embodiment, the electronic device 101 may detect that a power threshold (e.g., a remaining capacity of a battery) as indicated in a battery gauge of the electronic device 101 has depleted to be lower than a threshold power level during the operation of the multi-image frame photographing mode. The electronic device 101 may thus alter a performance operation or performance level of the operations of the device, and stop or end at least a part of a program which is being executed in the electronic device 101 to prevent the power level of the electronic device 101 from depleting sufficiently as to cause the device to shut down, and prolong continued maintenance of a specific function (e.g., such an outgoing call or a call reception, or data transmission and reception). The electronic device 101 may thus perform operation 503 to control a performance level of the device when an abnormal state has been detected as described above during an operation of the multi frame photographing mode, and may end the embodiment of FIG. 5A or perform operation 303 of FIG. 3 when the abnormal state of the electronic device 101 is not detected.

In operation 503, the electronic device 101 may control an operation of the multi-image frame photographing mode in accordance or in response to the detected abnormal state. According to an embodiment, the electronic device 101 may detect overheating in that a monitored component or module has a temperature larger than or equal to a threshold temperature, such as the processor 120, the memory 130, and the camera module 170, which are included in (or coupled to) the electronic device 101. The electronic device 101 may in some embodiments alter the number of photographic captures for a designated image frame in the multi-image frame photographing mode in accordance with the overheating abnormal state. For example, the electronic device 101 may capture additional visual noise in an image frame generated by the overheating when the image frame is photographed through the camera module 170. The electronic device 101 may increase the number of photographic captures for an image frame to be larger than a previously configured number of captures, and then photograph the image frame and may process the image to correct the generated visual noise.

According to another embodiment, the electronic device 101 may detect that the remaining capacity of the battery is lower than a threshold power level. This is a concern because the electronic device 101 may consume large quantities of power of the battery when executing the multi frame photographing operation due to the increase in the number of photographic captures of a designated image. The electronic device 101 may thus reduce a power consumption of the battery for sequentially executed photography by controlling (i.e., reducing) the number of photographic captures of the image frame.

When operation 503 is performed, the electronic device 101 may end the embodiment of FIG. 5A, or may perform operation 305 of FIG. 3.

Hereinafter, various embodiments of FIG. 5B will be described.

According to various embodiments, the electronic device 101 may control the number of frames to be photographed for use in exposure control of an image photographing operation and/or a combination, merge or correction of an image depending on whether an anti-shake correction function is used. According to an embodiment, operation 401 of FIG. 4 may correspond to an operation performed when a photographing condition (such as the number of times in which an image frame is photographed) has been determined based on an illumination value measured in the electronic device 101, or a magnification of a digital zoom, as seen in operation 303 of FIG. 3.

In operation 511, the electronic device 101 may determine whether the anti-shake correction function for image photographing is used. According to an embodiment, the electronic device 101 may perform operation 513 when the anti-shake correction function is used in the low illumination image processing mode, and may end the embodiment of FIG. 5 or perform operation 303 of FIG. 3 when the anti-shake correction function is not used.

In operation 513, the electronic device 101 may determine a shutter speed or a number of photographing frames. For example, the electronic device 101 may determine a shutter speed or a number of photographing frames based on the anti-shake correction function, and/or may determine the number of times in which an image frame photographed in the multi frame photographing mode is photographed. According to an embodiment, the electronic device 101 may control an exposure (e.g., an aperture value, shutter speed, or sensitivity of an image sensor) when an image is photographed in a low illumination state that is lower than a designated threshold value. The electronic device 101 may obtain an image having a higher quality when an image is photographed using the anti-shake correction function (e.g., optical anti-shake correction function “OIS”) in the low illumination situation, relative to when the anti-shake correction function is not used. Further, the electronic device 101 may use a fewer number of frames compared to when a high quality image is generated when the optical anti-shake correction function is not used, in using multiple image frames in order to generate a high quality image through the low illumination image processing scheme or a high-resolution image processing scheme when the optical hand-shack correction function is used. For example, the electronic device 101 may control the shutter speed of the electronic device 101 and may control the number of frames obtained based on the shutter speed in reference to an illumination value measured in the electronic device 101 when the optical anti-shake correction function is used. For example, when the optical anti-shake correction function is used, the electronic device 101 may control an image frame to be photographed at a shutter speed slower than when the optical anti-shake correction function is not used. According to an embodiment, when the optical anti-shake correction function is used at a time point when an image is photographed in low illumination, the electronic device 101 may obtain an image having a quality higher than when the optical anti-shake correction function is not used. Therefore, when the optical anti-shake correction function is used, the electronic device 101 may generate a high quality image through the low illumination image processing technique with the less number of frames than when the optical anti-shake correction function is not used.

According to another embodiment, when an electronic anti-shake correction scheme is used, the electronic device 101 may generate an effect of digital enlargement with a method of deleting and correcting an image frame outline area in the multiple image frames. Therefore, when the electronic anti-shake correction scheme is used and when the number of identical image frames is photographed to perform an anti-shake correction, an image having a quality lower than the optical anti-shake correction scheme may be obtained. The electronic device may determine and control to photograph an image frame by a larger number of times than that in the case of correcting an image in the optical anti-shake correction scheme, and thus can improve the quality of an image to be generated. In addition, when the electronic anti-shake correction function is used, the electronic device 101 may make a control to rapidly (e.g., more rapidly than a shutter speed in the case of using optical anti-shake correction function) determine a shutter speed, and may obtain an image frame which is clearer than a case of photographing an image frame at a relatively slow shutter speed.

Further, operation of FIG. 5B has described that a shutter speed determined based on the measured illumination and the number of times in which an image frame is photographed is changed depending on whether the anti-shake correction function is performed, but this is not limited thereto, and the shutter speed or the number of image frames to be photographed may be determined independently from the shutter speed according to a measured illumination value or the number of times the image frame is photographed.

The electronic device 101 may end the embodiment of FIG. 5B when performing operation 513.

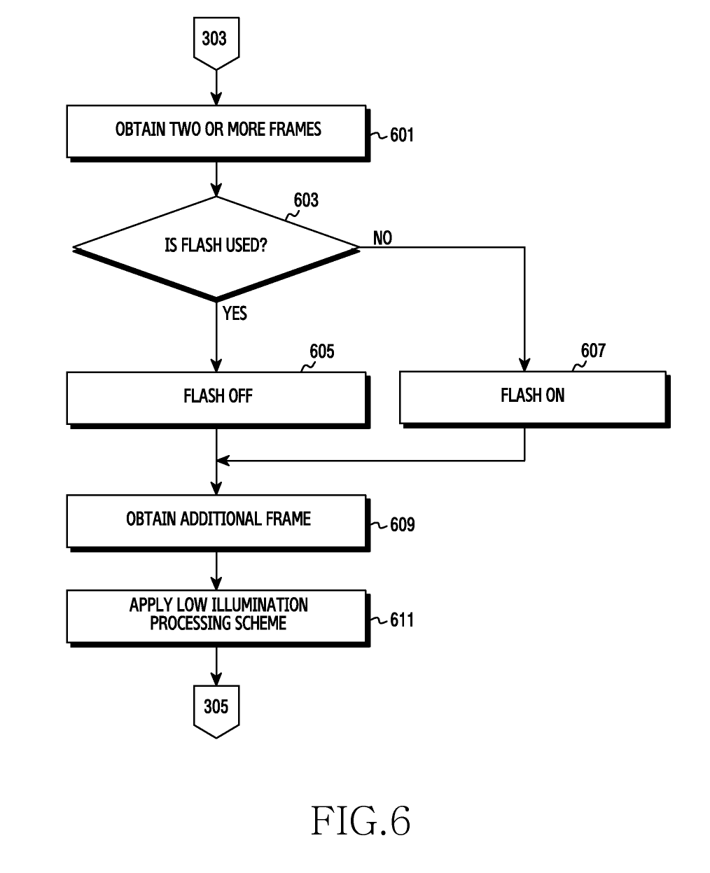

FIG. 6 is a flow chart illustrating a process of photographing an image depending on whether a flash function is used in an electronic device according to various embodiments of the present disclosure.

Operation 601 of FIG. 6 may be performed when a photographing condition has been detected (as in operation 303 of FIG. 3). The photographing condition may include the number of times in which an image frame is photographed based on a measured illumination value or a magnification of a digital zoom in the electronic device 101. Hereinafter, a description will be given of an operation of generating an image according to whether a flash is used by the electronic device 101 in the multi-image frame photographing mode.

In operation 601, the electronic device 101 may obtain two or more frames. For example, the electronic device 101 may photograph multiple image frames with a photographing condition of the multi-image frame photographing mode. According to an embodiment, the electronic device 101 may photograph, for example, seven frames to generate an image in the multi-image frame photographing mode. The electronic device 101 may thus photograph all seven frames in operation 601.

When a designated number of frames are photographed, then in operation 603, the electronic device 101 may determine whether a flash was used in the operation 601. The electronic device 101 may perform operation 605 when the flash is used and may perform operation 607 when the flash is not used.

That is, in operation 605, the electronic device 101 may disable use of the flash when an image frame was photographed using the flash in operation 603, allowing the electronic device 101 to photograph an image frame with the flash turned off.

Similarly, in operation 607, the electronic device 101 may configure a flash for use when an image frame is photographed without using the flash in operation 603. The electronic device 101 may photograph an image frame with the flash is turned on when operation 607 is performed. Herein, operation 605 or operation 607 may be an operation for a contrary configuration on the basis of whether the flash has been used in operation 603. In operation 609, the electronic device 101 may capture an additional frame. For example, the electronic device 101 may photograph an image either with or without the flash function, according to whether the flash is enabled or disabled in operations 605 and 607.

In operation 611, the electronic device 101 may apply a low illumination image processing scheme to the obtained additional frame. When operation 611 is performed, the electronic device 101 may end the embodiment of FIG. 6, or may perform operation 305 of FIG. 3.

When operation 305 of FIG. 3 is performed, the electronic device 101 may synthesize the image frame obtained through the multi-image frame photographing mode to generate a corrected image. According to an embodiment, in correcting resolution of an image in the low illumination image processing scheme, the electronic device 101 may generate a corrected image using the image frame in a state in which the flash is used, and the image frame in a state in which the flash is not used.

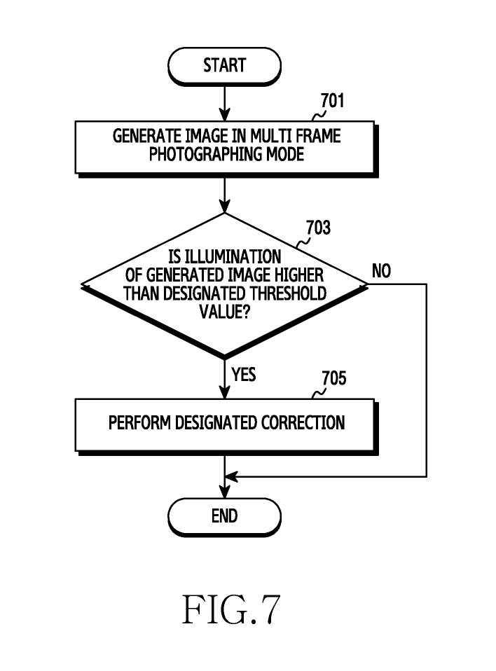

FIG. 7 is a flow chart illustrating a process of performing a correction depending on an illumination value of an image generated in an electronic device according to various embodiments.

Referring to FIG. 7, in operation 701, the electronic device 101 may generate an image in a multi frame photographing mode. For example, the electronic device 101 may generate a corrected image according to the multi-image frame photographing mode using the obtained image frame. According to an embodiment, the electronic device 101 may obtain multiple image frames of the designated number in accordance with an illumination value when a measured illumination value is lower than a designated threshold value, and correct resolution of an image or remove visual noise using the obtained multiple image frames.

In operation 703, the electronic device 101 may determine whether illumination of the generated image is higher than the designated threshold value. According to an embodiment, the electronic device 101 may perform operation 705 when the measured illumination value is higher than the designated numerical value, and may end the embodiment of FIG. 7 when the measured illumination value is lower than the designated numerical value.

In operation 705, the electronic device 101 may perform a designated correction. For example, the electronic device 101 may additionally execute a designated correction operation when illumination of an image generated based on configuration information of the electronic device 101 is higher than the designated threshold value. According to an embodiment, the correction operation to be applied may be a post-processing correction technique. The electronic device 101 may degrade a quality of an image when the post-processing technique is applied to a low illumination (or brightness) image. Therefore, the electronic device 101 may apply the post-processing technique when the illumination (or brightness) of the generated (or corrected) image is higher than a designated numerical value.

Subsequently, the electronic device 101 may terminate the embodiment of FIG. 7.

According to various embodiments of FIG. 7, the electronic device 101 may measure illumination of an image at the time of photographic capture, and then, according to the measured illumination, determine whether the post-processing technique is to be applied or whether the low illumination image processing scheme is to be used. According to an embodiment, the electronic device 101 may determine illumination of a designated numerical value based on the configuration information. For example, the electronic device 101 may determine a value and/or a b value as the designated illumination (e.g., reference illumination).

According to an embodiment, in the “a” value and the “b” value which are illumination values, the a value may be higher than the b value, and illumination measured in the electronic device 101 may be determined as an 1 value (lux, lx). When the 1 value is higher than the a value, correction for the illumination is not required as the amount of a light is sufficient and an image is photographed in the electronic device 101. The electronic device 101 may apply the post-processing technique without using the low illumination image processing scheme when the 1 value is higher than the a value.

According to an embodiment, when a b value is higher than the 1 value, a quality of an image is degraded when the post-processing technique is applied to the generated image in photographing an image in the electronic device 101 as the amount of light is insufficient. When the b value is higher than the 1 value, the electronic device 101 may use the low illumination image processing scheme and may not apply an effect such as whitening, smoothing, and sharpening.

According to an embodiment, when the 1 value is higher than the b value and lower than the a value, the low illumination image processing scheme may be used and the post-processing technique is applied to the generated image as an image is photographed in the electronic device 101. Further, the electronic device 101 may apply the post-processing technique when illumination of an image generated in the low illumination image processing scheme is higher than a designated numerical value (e.g., a c value).

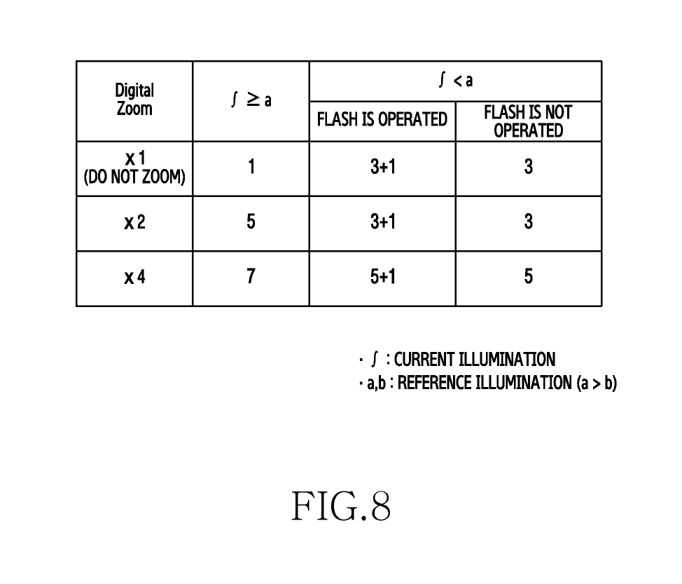

FIG. 8 illustrates the configuration of a table for determining the number of photographing frames for an image correction in an electronic device according to various embodiments of the present disclosure.

According to the various embodiments, when an image is photographed in a multi-image frame photographing mode, the electronic device 101 may, in using the multiple photographed image frames, use a low illumination image processing scheme based on a measured illumination value, and may use a high-resolution image processing scheme based on whether a digital zoom is used. In using the low illumination image processing scheme or the high-resolution image processing scheme, the electronic device 101 may photograph multiple image frames and may correct illumination or resolution using the obtained multiple image frames. In photographing the multiple image frames, the electronic device 101 may select or designate the number of image frames to be photographed based on a zoom magnification (e.g., of a digital zoom) or an illumination value. According to various embodiments, the electronic device 101 may use a table representing a reference value of elements for determining a photographing condition.

According to an embodiment, when the low illumination image processing scheme is used, the electronic device 101 may increase the number of image frames to be photographed as the illumination value of the electronic device 101 is low. The electronic device 101 may control, select or designate the number of image frames to be photographed in an inversely proportional relationship to the illumination value. For example, referring to FIG. 8, in an identical digital zoom magnification (e.g., ×1), the electronic device 101 may determine that the number (e.g., 3 or 3+1) of image frames to be photographed when an 1 value is lower than an a value (1=<a) is larger than the number (e.g., 1) of image frames to be photographed when the 1 value is higher than the a value (1>=a). Further, the electronic device 101 may control the number of the image frames to be photographed according to whether a flash is used in identical illumination (e.g., 1=<a). Referring to FIG. 8, although the number (e.g., 3+1) of image frames which is photographed when the flash is used in the identical illumination (e.g., 1=<a) is larger than the number (e.g., 3) of image frames to be photographed when the flash is not used, this is not limited thereto, and the number of the image frames to be photographed when the flash is not used may be determined to be larger than or identical to the number of the image frames to be photographed when the flash is used.

According to an embodiment, when the high-resolution image processing scheme is used, the electronic device 101 may increase the number of image frames to be photographed as the magnification of digital zoom of the electronic device 101 is high. For example, referring to FIG. 8, the electronic device 101 may determine that the number (e.g., 5) of image frames to be photographed when 2 times zoom (e.g., ×2) in is performed in identical illumination (e.g., 1>=a) is larger than the number (e.g., 1) of image frames to be photographed when 1 time zoom (e.g., ×1) in is performed in identical illumination (e.g., 1>=a). Since degradation of resolution is largely generated as a magnification of a digital zoom increases when an image extends through the digital zoom, the electronic device 101 may increase the number of image frames used for an image correction, thereby increasing a probability which can correct the image.

The electronic device 101 is not limited to independently distinguish the low illumination image processing scheme with the high resolution image processing scheme and then determine the number of image frames, and may determine the number of image frames to be photographed complexly using the illumination value and the magnification of the digital zoom. Further, it is obvious that the electronic device 101 can control the number of image frames to be photographed according to whether the anti-shake correction function is used. For example, when the anti-shake correction function is used in the low illumination image processing scheme or the high-resolution image processing scheme, the electronic device 101 may determine a less number of image frames than the number of image frames to be photographed in the existing low illumination image processing scheme or the number of image frames to be photographed in the high-resolution image processing scheme.

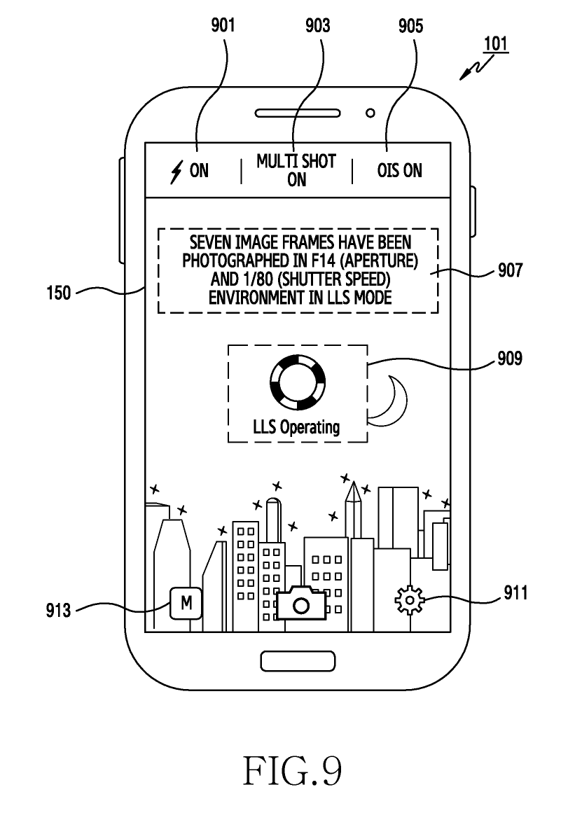

FIG. 9 is a view illustrating a configuration of a screen for photographing an image in a multi-image frame photographing mode of an electronic device according to various embodiments of the present disclosure.

According to various embodiments, in photographing an image, the electronic device 101 may photograph an image in a multi-image frame photographing mode when a measured illumination value is lower than a designated illumination. The electronic device 101 may display that the multi-image frame photographing mode is applied on a display of the electronic device, or on another display module operatively coupled to the electronic device. For example, the electronic device 101 may display that the multi-image frame photographing mode is being applied, using an icon, a character, a pop-up window, or another graphic object. Further, the electronic device 101 may display a user input window for asking whether the multi-image frame photographing mode is applied. When photographing an image in the multi-image frame photographing mode, the electronic device 101 may photograph multiple image frames and then synthesize the multiple image frames into one image. When an image is photographed in the low illumination image processing scheme, the electronic device 101 may display a photographing condition of the camera module 170 and/or information such as the number of photographed image frames on the display 150. The electronic device 101 may display state information configured in a photographing mode (e.g., a mode of photographing an image through the image processing program 135) on the display 150.

According to an embodiment, the electronic device 101 may display status information on the display 150, including flash status 901, a photographing scheme (e.g., the multi-image frame photographing mode) 903, and anti-shake correction function 905 is used. Further, the electronic device 101 may display an indicator 913 to show presence or activation of a function, such as a correction function or an optical character recognition or “OCR” mode provided through the image processing program 135. The electronic device 101 may also display a menu 911 selectable to alter configuration for photography in the image processing program 135. When an image is photographed in the multi-image frame photographing mode, the electronic device 101 may display a photographic condition such as an aperture value (e.g., F14) and a shutter speed (e.g., 1/80) and may display a number of image frames captured 907 (e.g., “seven”) in accordance with an illumination value measured in the multi-image frame photographing mode.

Further, the electronic device 101 may display an operation state 909 of indicating synthesizing of an image by applying the low illumination image processing scheme to the image frame photographed in the multi-image frame photographing mode. The operation state 909 may include display of a lapse of time for processing the image. In displaying the operation state 909 for processing an image frame, the electronic device 101 may further display an operation state for a high-resolution image processing scheme, or when two or more processing schemes operate together, without being limited to only display of the low illumination image processing scheme.

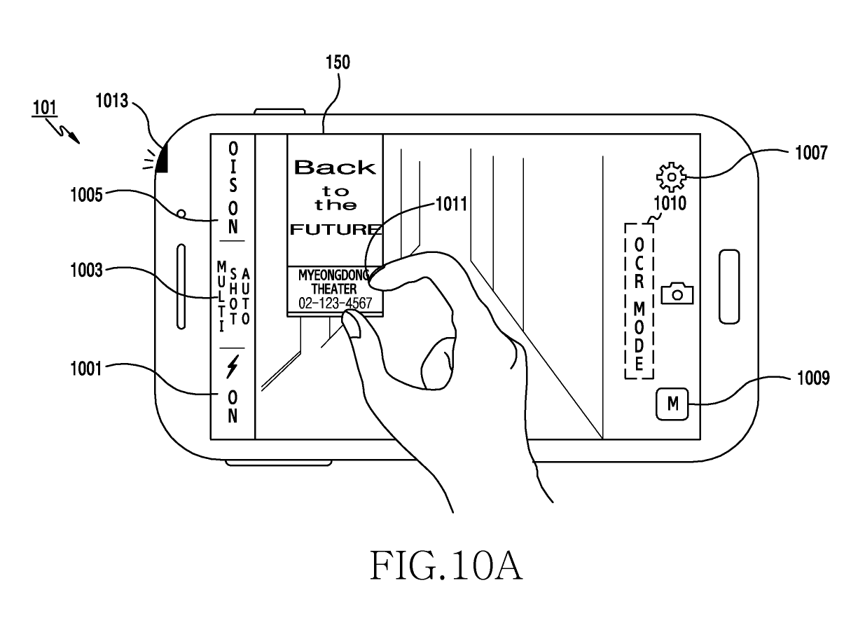

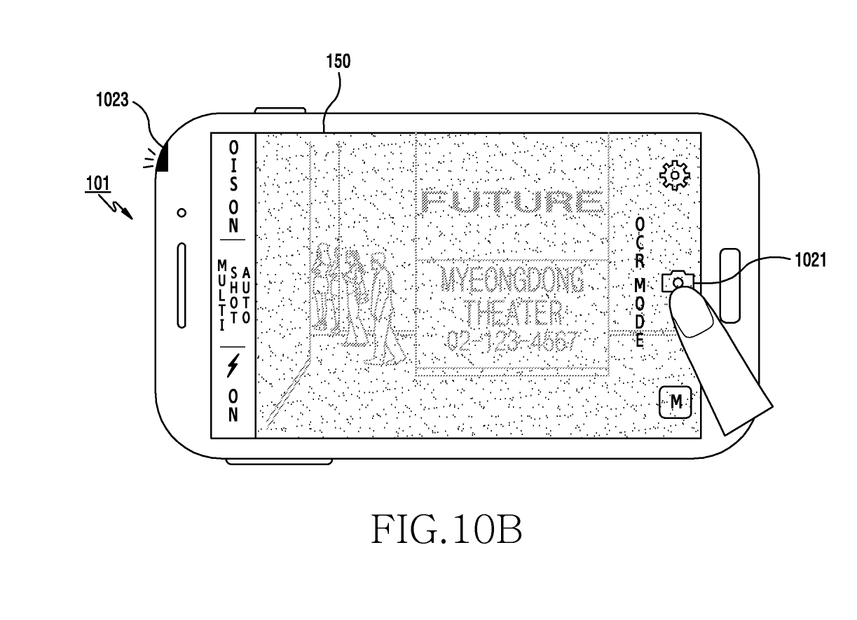

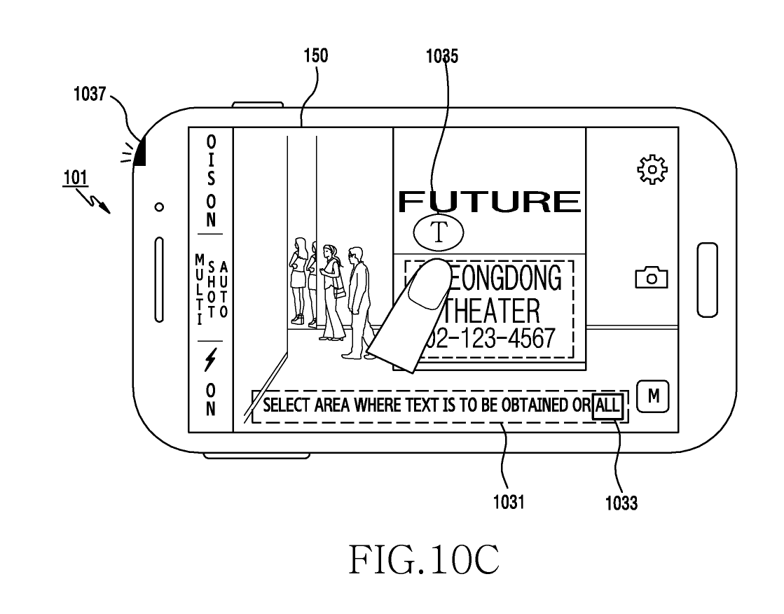

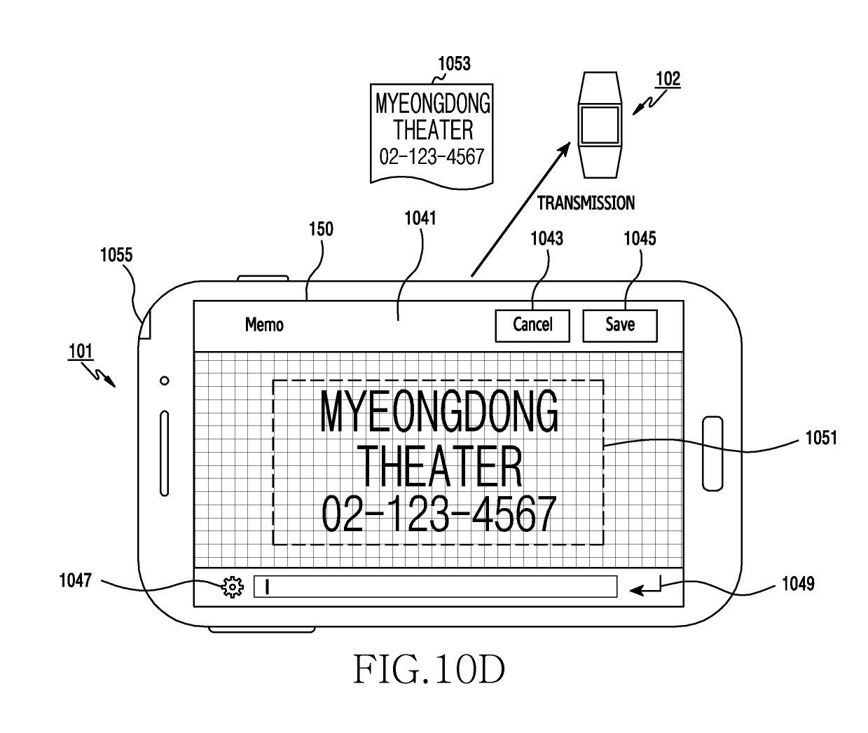

FIGS. 10A, 10B, 10C and 10D illustrate a screen configuration for performing an additional function in a multi-image frame photographing mode in an electronic device according to various embodiments, of the present disclosure.

According to various embodiments, when the electronic device 101 operates as a specific mode (e.g., an optical character recognition of reading “OCR” mode) in photographing an image, the electronic device 101 may perform an image correction (e.g., a low illumination image processing scheme, or a high-resolution image processing scheme) together depending on whether measured illumination or a digital zoom is used. The electronic device 101 may generate an image through the multi-image frame photographing mode and perform a designated operation (i.e., obtaining a text through the OCR function).

Hereinafter, various embodiments of FIG. 10A will be described.

Referring to FIG. 10A, an electronic device 101 may display information on an operating mode of a photographic function of the electronic device 101 when photographing an image through the image processing program 135. According to an embodiment, the electronic device 101 may display an image photographing interface of the image processing program 135 on the display 150. The electronic device 101 may display an image frame obtained through the camera module 170 on the display 150. The electronic device 101 may display a state of the operating functions for photographing an image based on configuration information in a designated area of the display 150 which displays an image frame. For example, when photographing an image, the electronic device 101 may display an operation state of a flash function 1001, an operation state of the multi-image frame photographing mode 1003, or an operation state of an anti-shake correction function 1005. Further, the electronic device 101 may display a configuration menu 1007 selectable to change the configuration of the image processing program. The electronic device 101 may allow, through the configuration menu 1007, configuration of a function, such as the flash function, the multi-image frame photographing mode, and the anti-shake correction function, as provided in the image processing program 135. In addition, the electronic device 101 may display a menu indicator 1009 for a photographic effect (e.g., an effect which is adaptable to capture images in a variety of photographic modes or “scene” modes, such as “sports,” “landscape,” or image modifiers such as “sketch” and “cartoon”) provided in the image processing program 135 to be selected.

According to an embodiment, the electronic device 101 may display as indicated by reference numeral 1010 information on an operation (e.g., an OCR mode) which is being performed based on a user input. The electronic device 101 may display a designated photographing condition in the electronic device 101 in operating the image processing program 135 in the OCR mode. For example, when the image processing program 135 is being operated in the OCR mode, the electronic device 101 may detect that an image frame displayed on the display 150 expands through the camera module 170 based on a user input 1011. The electronic device 101 may be operated in the multi-image frame photographing mode when it is determined that an image frame expands through a digital zoom. The electronic device 101 may display information 1003 that the electronic device is operating in the multi-image frame photographing mode on a designated location of the display 150. In addition, the electronic device 101 include a display device such as an indicator 1013 with regard to the operation in a designated mode (e.g., the multi-image frame photographing mode). When the indicator 1013 displays an operating state in the multi-image frame photographing mode, the electronic device 101 may operate the indicator to output a designated color or a designated light-emitting pattern.

Hereinafter, various embodiments of FIG. 10B will be described.

Referring to FIG. 10B, an electronic device 101 may determine or set a magnification of a digital zoom based on a user input 1021, and may photograph an image according to the determined magnification of digital zoom. The electronic device 101 may determine a photographing condition, such as the number of times in which an image frame is photographed, based on the multi-image frame photographing mode. According to an embodiment, with reference to measured illumination or a magnification of a digital zoom, the electronic device 101 may determine, set or select the number of times in which an image frame is photographed to be larger or smaller than a reference value (e.g., a reference value for illumination or a magnification of digital zoom). The electronic device 101 may photograph the image frame according to a photographing condition and apply a designated image correction scheme. For example, in photographing an image, the electronic device 101 may determine that a digital zoom is used, and may use a high-resolution image processing scheme as an image correction scheme. The electronic device 101 may display a correction operation which is being processed on the display 150 of the electronic device 101, or may display the correction operation through an indicator 1023 included in the electronic device 101. According to an embodiment, the electronic device 101 may display information on the high-resolution image processing scheme using the indicator 1023 rather than the indicator 1013 of FIG. 10A.

Hereinafter, various embodiments of FIG. 10C will be described.

Referring to FIG. 10C, an electronic device 101 may perform an OCR mode based on a corrected (or generated) image using an image processing scheme. As seen in FIG. 10C, an image may be which improves a quality of an uncorrected image frame, which is displayed on the display 150 using a high-resolution image processing scheme. The electronic device 101 may perform an OCR operation on a generated image, and may display information obtained through the OCR operation on the display 150. According to an embodiment, the electronic device 101 may obtain or extract at least one of a text, character, number, symbol, special character, and character string from the image by performing the OCR operation, and may display the detected information in the electronic device 101. For example, when a text is obtained in an image by performing the OCR operation, the electronic device 101 may control the indicator 1037 to emit light of a designated color or in a designated pattern. The electronic device 101 may display a message 1035 near or within an area where the text is obtained from the OCR operation, disposed over or in the image displayed on the display 150, and may further display an instructive message (e.g., “select an area where a text is to be obtained or ALL which are indicated by reference numeral 1031”) on a designated location of an image frame displayed on the display 150 of the electronic device 101. The electronic device 101 may receive a selection of the message 1035 corresponding to a part of text included in the image, and then obtain or extract text corresponding to the selection, and/or obtain or extract all text included in the image when a selection is detected for the message 1033, which is configured to allow selection of a whole.

Hereinafter, various embodiments of FIG. 10D will be described.

Referring to FIG. 10D, the electronic device 101 may obtain or extract a text string 1051 corresponding to a selected message (e.g., the message 1035). The electronic device 101 may transmit the obtained text to a designated program (e.g., a memo program 1041). In addition, the electronic device 101 may transmit the text 1051 to another electronic device (e.g., an electronic device 102), which may have been designated when the text was obtained. The electronic device 101 may configure the obtained text 1051 as data 1053 in a designated format, and then transmit the data 1053 to another electronic device (e.g., the electronic device 102). The electronic device 101 may correct the text 1051 that is displayed in the memo program 1041 with a scheme or function provided in the memo program, and display a save icon 1045 selectable to allow saving of the text 1051, and a delete icon (e.g., “cancel”) 1043 selectable to delete the text without saving.

Various embodiments which are performed by the electronic device 101 may be performed under a control of a processor 120. In addition, the electronic device 101 may include a module separate from the processor 120 which is programmed to control various embodiments of the present specification. The separate module programmed to control the various embodiments of the present specification may operate under a control of the processor 120.

According to various embodiments, the processor 120 may determine a multi-image frame photographing mode, determine a photographing condition including the number of times in which an image frame is photographed, and generate an image of designated resolution based on multiple image frames obtained according to the determined photographing condition. According to an embodiment, the processor 120 may determine the multi-image frame photographing mode based on illumination around the electronic device or object illumination. According to an embodiment, the processor 120 may determine the multi-image frame photographing mode when a value of illumination around the electronic device or object illumination is less than or equal to a designated illumination value. According to an embodiment, the processor 120 may determine the multi-image frame photographing mode based on a magnification of a digital zoom. According to an embodiment, the processor 120 may include at least one of resolution, a shutter speed, or a size of an image frame as a photographing condition. According to an embodiment, the processor 120 may apply a super resolution technique to multiple image frames and then generate an image of a designated resolution. According to an embodiment, the processor 120 may generate the designated resolution image by applying a low illumination processing (low light shot) technique to multiple image frames. According to an embodiment, the processor 120 may display whether the multi-image frame photographing mode is being used, in the electronic device. According to an embodiment, the processor 120 may determine the photographing condition based on at least one among whether an anti-shake correction function is used, a magnification of a digital zoom, or whether a flash function is used. According to an embodiment, the processor 120 may obtain at least a part of a character, a symbol, a number, and a character string which are included in an obtained image, by applying an optical character reading technique.

According to various embodiments, the processor 120 may detect illumination or a magnification of a digital zoom to enter into a low illumination image processing mode or a digital zoom image processing mode, and determine the number of image frames to be used in the low illumination image processing mode or the digital zoom image processing mode according to the detected illumination value or the detected digital zoom magnification value. According to an embodiment, the processor 120 may determine the number of the image frames so as to be inversely proportion to the detected illumination value according to an increase of the detected illumination value. According to an embodiment, the processor 120 may determine the number of the image frames so as to be inversely proportion to the digital zoom magnification value according to an increase of the digital zoom magnification value. According to an embodiment, the processor 120 may additionally include and determine whether an anti-shake correction function or a flash is used in determining the number of image frames. According to an embodiment, the processor 120 may determine the number of image frames to be lower when the hand-shack correction function is used. According to an embodiment, the processor 120 may process an image frame to be obtained according to the number of determined image frames when entering into the low illumination image processing mode, generate a high-resolution image by synthesizing the multiple obtained image frames, and apply a post-processing technique to the generated image when resolution of the generated image is satisfied with a designated numerical value. According to an embodiment, the processor 120 may process an image frame to be obtained according to the number of determined image frames when entering into the high-resolution image processing mode, may process at least one image, where resolution is corrected, by synthesizing the multiple obtained image frames to be generated and a text included in at least a part of the generated image to be obtained. According to an embodiment, the processor 120 may process the obtained text to be transmitted to another designated electronic device through a communication interface.

Each of the above described elements of the electronic device according to various embodiments of the present disclosure may include one or more components, and the name of a corresponding element may vary according to the type of electronic device. The electronic device according to various embodiments of the present disclosure may include at least one of the above described elements or may exclude some of the elements or further include other additional elements. Further, some of the elements of the electronic device according to various embodiments of the present disclosure may be coupled to form a single entity while performing the same functions as those of the corresponding elements before the coupling.

According to various embodiments of the present disclosure, at least some of the devices or methods according to various embodiment of the present disclosure as defined by the appended claims and/or disclosed herein may be implemented in the form of hardware, software, firm ware, or any combination (e.g., module or unit) of at least two of hardware, software, and firmware. The “module” may be interchangeable with a term, such as a unit, a logic, a logical block, a component, or a circuit. The “module” may be a minimum unit of an integrated component element or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), or a programmable-logic device for performing operations which has been known or are to be developed hereinafter. If implemented in software, a computer-readable storage medium (or storage medium readable by a computer) storing at least one program (or programming module) may be provided. The software may, for example, be implemented by instructions stored in a computer-readable storage medium in the form of a programming module. The at least one program may include instructions that cause the electronic device to perform the methods according to various embodiments of the present disclosure as defined by the appended claims and/or disclosed herein. When he command is executed by one or more processors (for example, the processor 120), the one or more processors may execute a function corresponding to the command. The computer-readable storage medium may, for example, be the memory 230. At least a part of the programming module may, for example, be implemented (e.g., executed) by the processor 220. At least a part of the programming module may, for example, include a module, a program, a routine, a set of instructions, or a process for performing at least one function.

The computer-readable storage medium may include magnetic media such as a hard disc, a floppy disc, and a magnetic tape; optical media such as a compact disc read only memory (CD-ROM) and a digital versatile disc (DVD); magneto-optical media such as a floptical disk; a hardware device specifically configured to store and execute program instructions (e.g., programming module), such as a read only memory (ROM), a random access memory (RAM), and a flash memory; an electrically erasable programmable read only memory (EEPROM); a magnetic disc storage device; any other type of optical storage device; and a magnetic cassette. Alternatively, any combination of some or all of the may form a memory in which the program is stored. Further, a plurality of such memories may be included in the electronic device. In addition, the program instructions may include high class language codes, which can be executed in a computer by using an interpreter, as well as machine codes made by a compiler.

According to various embodiments, the electronic device 101 may include a non-temporary computer readable storage medium where a program for executing a method is stored in an electronic device, the method including: an operation of detecting illumination or a magnification of a digital zoom to enter into a low illumination image processing mode or a digital zoom image processing mode, and an operation of determining the number of image frames to be used in the low illumination image processing mode or the digital zoom image processing mode according to the detected illumination value or the detected digital zoom magnification value.

In addition, the program may be stored in an attachable storage device capable of accessing the electronic device through a communication network such as the Internet, an intranet, a local area network (LAN), a wide LAN (WLAN), a storage area network (SAN), or any combination thereof. Such a storage device may access the electronic device via an external port. Further, a separate storage device on the communication network may access a portable electronic device. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

The embodiments of the present disclosure disclosed herein and shown in the drawings are merely specific examples presented in order to easily describe technical details of the present disclosure and to help the understanding of the present disclosure, and are not intended to limit the present disclosure. Therefore, it should be construed that, in addition to the embodiments disclosed herein, all modifications and changes or modified and changed forms derived from the technical idea of the present disclosure fall within the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A method in an electronic device, the method comprising:
determining, by at least one processor, a photographic condition and selecting a number of photographic captures to be executed in a multi-image frame photographing mode based on the determined photographic condition;
capturing, by a camera, multiple image frames based on the selected number of photographic captures; and
generating an image having a predetermined image resolution from the captured multiple image frames.

2. The method of claim 1, wherein the photographic condition includes at least one of illumination of an environment around the electronic device, or illumination on an object to be photographed.

3. The method of claim 1, wherein generating the image further comprises synthesizing the captured multiple image frames into the image using a low illumination image processing technique.

4. The method of claim 1, wherein the photographic condition includes at least a digital zoom magnification level.

5. The method of claim 1, wherein generating the image having the predetermined image resolution from the captured multiple image frames further comprises synthesizing the captured multiple image frames using a digital zoom magnification image processing technique.

6. The method of claim 1, wherein the photographic condition further comprises at least one of a shutter speed, an image frame size, and an image resolution.

7. The method of claim 1, wherein the photographic condition further comprises whether a anti-shake correction is used, whether a flash function is used, and whether magnification via a digital zoom is applied.

8. The method of claim 1, further comprising:
displaying on at least one of a display or an indicator of the electronic device an image indicating whether the multi-image frame photographing mode is active.

9. The method of claim 1, further comprising:
executing optical character recognition on the generated image to extract at least one of a character, a symbol, a number, and a character string included in the generated image.

10. The method of claim 9, further comprising:
transmitting the extracted at least one of the character, symbol, number, and character string to an external electronic device or to a preselected application.

11. An electronic device comprising:
an image sensor;
an illumination sensor; and
at least one processor configured to:
determine a photographic condition and select a number of photographic captures to be executed in a multi-image frame photographing mode based on the determined photographic condition,
control the image sensor to capture multiple image frames based on the selected number of photographic captures, and
generate an image having a predetermined image resolution from the captured multiple image frames.

12. The electronic device of claim 11, wherein the photographic condition includes at least one of illumination of an environment around the electronic device or illumination on an object to be photographed.

13. The electronic device of claim 11, wherein the at least one processor is further configured to generate the image by synthesizing the captured multiple image frames into the image using a low illumination image processing technique.

14. The electronic device of claim 11, wherein the photographic condition includes at least a digital zoom magnification level.

15. The electronic device of claim 11, wherein the at least one processor is further configured to generate the image by synthesizing the captured multiple image frames using a digital zoom magnification image processing technique.

16. The electronic device of claim 11, wherein the photographic condition further comprises at least one of a shutter speed, an image frame size, and an image resolution.

17. The electronic device of claim 11, wherein the photographic condition further comprises whether an anti-shake correction is used, whether a flash function is used, and whether magnification via a digital zoom is applied.

18. The electronic device of claim 11, wherein the at least one processor is further configured to control at least one of a display or an indicator of the electronic device to indicate whether the multi-image frame photographing mode is active.

19. The electronic device of claim 11, wherein the at least one processor is further configured to execute optical character recognition on the generated image to extract at least one of a character, a symbol, a number, and a character string included in the generated image.

20. A non-transitory computer-readable medium storing a program executable by at least one processor of an electronic device to cause the electronic device to:
determine, by the at least one processor, a photographic condition and selecting a number of photographic captures to be executed in a multi-image frame photographing mode based on the determined photographic condition;
capture, by a camera, multiple image frames based on the selected number of photographic captures; and
generate an image having a predetermined image resolution from the captured multiple image frames.
